(19) United States
(12) Patent Application Publication
(10) Pub. No.: US 2017/0008125 A1
(43) Pub. Date: Jan. 12, 2017

(54) FLUX-ASSISTED DEVICE ENCAPSULATION

(71) Applicant: SIEMENS ENERGY, INC., Orlando, FL (US)

(72) Inventors: Gerald J. Bruck, Oviedo, FL (US); Ahmed Kamel, Orlando, FL (US)

(21) Appl. No.: 14/514,838

(22) Filed: Oct. 15, 2014

(51) Int. Cl. B23K 26/34; G01K 1/14; B23K 26/70

(52) U.S. Cl. CPC B23K 26/34; B23K 26/703; G01K 1/14; B23K 2201/36

(57) ABSTRACT

There are provided processes for encapsulating a device 14 on a substrate 12 utilizing a flux material 18. The incorporation of the flux material 18 substantially reduces oxide formation and porosity in the cladding 24 that encapsulates the encapsulated device 14.

### FIELD OF THE INVENTION

This invention relates generally to the field of metals joining, and more particularly to the encapsulation of a device, such as a monitoring instrument, on a substrate utilizing a flux material in order to substantially reduce or eliminate oxides or porosity in the resulting product.

### BACKGROUND OF THE INVENTION

Thermal spray deposition involves melting or softening particulates and splat impact with the substrate resulting in a fine grained polycrystalline coating. U.S. Pat. No. 6,576,861 to Sampath et al., for example, describes fine thermal spray deposition using collimators and apertures to define a path of material from sources such as combustion sprays, plasma sprays, detonation guns, and HVOF apparatus. In addition, U.S. Pat. No. 6,576,861 describes such processing as useful for printing multilayer electrical components with materials of varying properties. The deposits generally have up to ten percent porosity and contain oxides from entrained air. Oxides and porosity result in deposit tensile strength in the range of 10 to 60 percent of cast or wrought material. In thermal spraying, unmelted or partially unmelted particulates also lead to poor bond strength in the deposit. If such inferior material used to encapsulate monitoring instruments fails, then important diagnostic information (e.g., heat flux, strain, wear) will be lost.

### BRIEF DESCRIPTION OF THE DRAWINGS

The invention is explained in the following description in view of the drawings that show:

FIGS. 1A-1B illustrate a process for encapsulating a device in accordance with an aspect of the present invention.

FIG. 2 illustrates a thermocouple to be encapsulated in accordance with an aspect of the present invention.

FIG. 3A-3H illustrate a process for forming an encapsulated thermocouple in situ in accordance with another aspect of the present invention.

FIG. 4 illustrates a sleeving pre-form in accordance with an aspect of the present invention.

FIGS. 5A-5B illustrate a process for encapsulating a device utilizing a pre-sintered pre-form in accordance with an aspect of the present invention.

### DETAILED DESCRIPTION OF THE INVENTION

In accordance with one aspect, there are provided joining processes that substantially improve the mechanical properties of deposits made for encapsulating devices. In particular, there are provided processes for forming an encapsulated device on a substrate utilizing a flux material in the processes. Advantageously, by utilizing the flux material, the deposited material, upon solidification, may be substantially free from oxides and porosity due to the effective shielding and cleansing afforded by the flux material and resulting slag formation. The encapsulated device may include instrumentation such as devices for monitoring temperature, heat flux, strain, and wear monitoring equipment, wires, thermocouples, or the like. In addition, the device may be encapsulated by an encapsulating material which is compatible with the underlying substrate such that in a laser welding process, for example, the resulting cladding formed from the encapsulating material forms a strong bond with the substrate to anchor the device to the substrate.

As used herein, the term “joining” refers to a process such as welding for the joinder of two or more substrates, as well as the repair or enhancement of one or more substrates.

As used herein, the term “encapsulating” means that at least a portion of the device is surrounded by the encapsulating material as described herein. In certain embodiments, the device is fully encompassed by or buried within the encapsulating material.

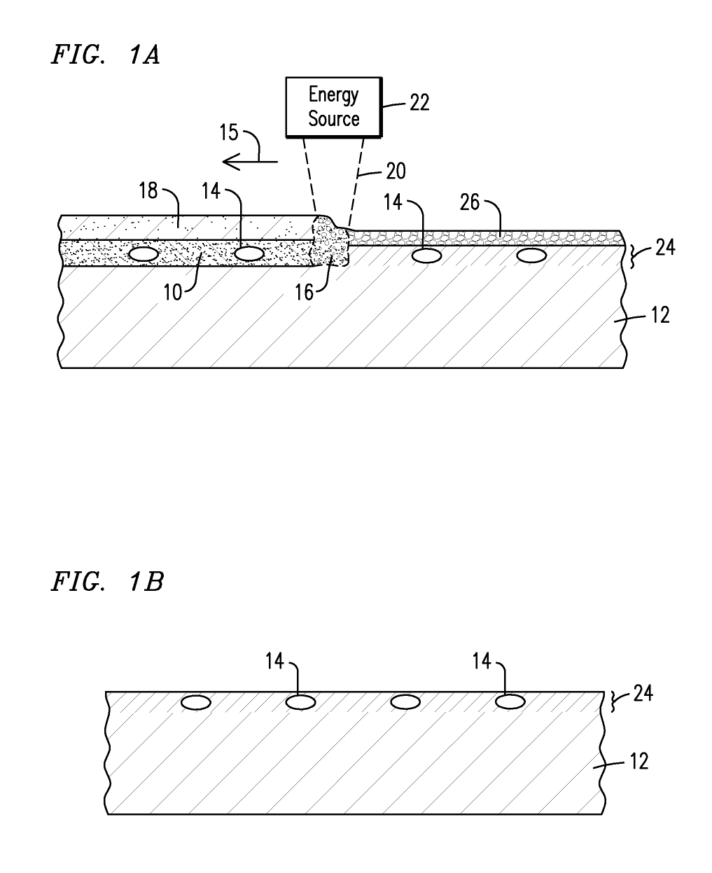

Referring now to the figures, FIG. 1A illustrates an embodiment of a process that provides an encapsulated device substantially free of oxides and porosity, and further having excellent bond strength with the underlying substrate. As shown, an encapsulating material 10 in the form of a powder is placed on a substrate 12. One or more devices 14 (hereinafter “a device 14”) to be encapsulated by the encapsulating material 10 may be pre-placed at least partially within the material 10. Alternatively, the device 14 may be positioned or otherwise inserted at least partially within the encapsulating material 10 as the material 10 is added to the substrate 12. For example, some encapsulating material 10 may be applied to the substrate 12; the device 14 may be placed on the encapsulating material 10; and thereafter further encapsulating material 10 may be placed on the device 14. Alternatively, the device 14 may be applied to the substrate 12 directly and the encapsulating material 10 may be disposed or applied over the device 14.

In any case, in the embodiment shown, a layer of powdered flux material 18 may also be placed over the encapsulating material 10 and the device 14. Alternatively, the flux material 18 may be mixed with the encapsulating material 10 and applied to the substrate 12. Still further alternatively, the flux material 18 may be manufactured as a common particulate with the encapsulating material as conglomerate particles. To apply energy to the desired components, energy 20 from a suitable energy source 22 is traversed over the components (10, 14, and/or 18) in an amount effective to melt at least the flux material 18 into a melt pool 16. In certain embodiments, as with a superalloy material, for example, the encapsulating material 10 is also melted into the melt pool 16. In other embodiments, as with a ceramic material, the encapsulating material 10 is sintered rather than melted. To accomplish the desired melting and/or sintering, at least one of the energy source 22 and the substrate 12 is moved in the direction of arrow 15 with respect to the other of the energy source 22 and the substrate 12.

In certain embodiments, the device 14 may not melt at the temperature at which the flux powder 18 is melted, or may not melt at the temperature at which the encapsulating, material 10 and the flux powder 18 melt if both are melted. It is understood that the present invention is not so limited, however, as will be described in further embodiments below where the device 14 (or components utilized for the formation thereof) may be intentionally melted to form an intended product. In certain embodiments, a depth of the substrate 12 is also melted by the energy source 20 such as is done in a typical laser welding or cladding process. In one embodiment, the depth of the substrate 12 melted is from 0.05 to 1.0 mm.

Once the melt pool 16 is allowed to cool (passively or actively), a cladding 24 is present or formed on the substrate 12 which encapsulates the device 14. The cladding 24 is covered by a layer of slag 26 as shown in FIG. 1A. After completion of the application of energy over the targeted area, the slag 26 may be removed to leave the cladding 24 which encapsulates the device 14 as shown in FIG. 1B. The cladding 24 will be substantially free of oxides and porosity and includes excellent bond strength to the underlying substrate 12. In an embodiment, the amount of oxides and porosity in the cladding 24 may each be less than 10%, and preferably less than 5% by volume, thereby resulting in a device 14 encapsulated in a material having significantly higher tensile strength relative to one prepared by known processes.

The substrate 12 may comprise any material with which would benefit from any of the processes described herein. In certain embodiments, the substrate 12 comprises a superalloy material. As noted above, the term “superalloy” is used herein as it is commonly used in the art to refer to a highly corrosion-resistant and oxidation-resistant alloy that exhibits excellent mechanical strength and resistance to creep even at high temperatures. Exemplary superalloys include, but are not limited to alloys sold under the trademarks and brand names Hastelloy, Inconel alloys (e.g., IN 738, IN 792, IN 939), Rene alloys (e.g. Rene N5, Rene 41, Rene 80, Rene 108, Rene 142, Rene 220), Haynes alloys, Mar M, CM 247, CM 247 LC, C263, 718, X-750, ECY 768, 262, X45, PWA 1483 and CMSX (e.g. CMSX-4) single crystal alloys, GTD 111. GTD 222, MGA 1400, MGA 2400, PSM 116, CMSX-8, CMSX-10, PWA 1484, IN 713C, Mar-M-200, PWA 1480, IN 100, IN 700, Udimet 600, Udimet 500 and titanium aluminide.

Alternatively, the substrate 12 may comprise a ceramic material including but not limited to a ceramic matrix composite (CMC) material or a monolithic ceramic comprising one or more of alumina, zirconia, silicon carbide, silicon nitride, aluminum nitride, silicon oxynitride, silicon carbonitride, mullite, cordierite, beta spodumene, aluminum titanate, strontium aluminum silicate, or lithium aluminum silicate. In the case of non-electically conductive substrates such as many ceramics and in the case of devices that require electrical insulation between their wires (e.g. thermocouples), it is appreciated that it may not be necessary to fully encapsulate the device 14, but rather to melt the wires of the device directly to the substrate, thereby allowing the substrate itself provide the insulation.

The encapsulating material 10 for the processes described herein may comprise any suitable material that is compatible with the substrate 12. In an embodiment, the encapsulating material 10 (and thus resulting cladding 24) and the substrate 12 each comprise a superalloy material. In this way, when the encapsulating material 10 and a depth of the substrate 12 are melted, for example, the cladding 24 or cooled material will form a metallurgically compatible weld with high bond strength to the substrate 12. In other embodiments, the encapsulating material 10 (and thus resulting cladding 24) and the substrate 12 may comprise a ceramic material. It is appreciated the encapsulating material 10 (as well as other materials) may be provided in any suitable form such as in the form of a powder, a pre-form, a fabric or a wire. The encapsulating material 10 may also be placed on the substrate 12 by any suitable method such as deposition, placement, via a feeding mechanism or the like. Exemplary methods of deposition and forms for the components (wires, pre-forms, powders, and the like) are described, in U.S. Patent Publication No. 2013/0136868, the entirety of each of which is hereby incorporated by reference herein.

The device 14 to be encapsulated may be any material or component, which following solidification of the melt pool 16, comprises a material or product distinct from the encapsulating material 10 and/or substrate 12. In certain embodiments, the device 14 comprises a material that provides a distinct and/or an additional property to the substrate 12. In further embodiments, the device 14 comprises an instrument such as one or more instruments or devices for monitoring temperature, heat flux, loads, strain, wear, or any other desired measurable property. When encapsulated as described herein, the instrument may carry out its intended function on the substrate 12. In certain embodiments, the device 14 comprises a pre-assembled instrument ready for operation. In other embodiments, the device 14 may comprise one or more components for assembly in situ via one of the processes described herein. The function of device 14 is not limited to diagnostics. For example, the device 14 may be used, for example, to heat or cool the substrate or to produce an electromagnetic field near the substrate surface with such functions affecting the substrate's physical condition or response to (or effect on) external fields respectively.

In a particular embodiment, the device 14 comprises a thermocouple or materials suitable for forming a thermocouple on the substrate 12 which will be encapsulated by a cladding 24 formed from the encapsulating material 10. A thermocouple is understood to be a thermoelectric device for measuring temperature and typically comprises two wires of different metals connected at a common termination point for temperature measurement at that location. A voltage is developed as a function of the temperature gradient between the junction and along the wires. Greater or lesser temperatures at the junction create greater or lesser temperature gradients, thereby afftecting the resultant voltage.

In one embodiment, the device 14 comprises a fully assembled thermocouple which may be deposited on the substrate 12 and which may be encapsulated according to any process described herein, including that shown in FIGS. 1A-1B. In particular, thereafter or simultaneously therewith, the encapsulation material 10 and the flux material 18 may be deposited on the substrate 12 over the device 14 (thermocouple). Energy 20 may be applied, the components allowed to cool, and the slag 26 is removed as explained above to leave behind a cladding 24 that encapsulates a thermocouple. FIG. 2 shows a thermocouple 30 as comprising a sheath material 36 disposed about two thermocouple materials 34A, 34B.

In this embodiment, the assembled thermocouple 30 may comprise any suitable materials that will not be melted by the energy 20 during an associated process. For example, the thermocouple materials 34A, 34B may separately comprise one or more materials selected from Table 1 below. Typically, the materials 34A and 34B differ in composition at least to a certain extent. As shown by Table 1, the thermocouple materials 34A, 34B may each have a melting temperature that is well above the expected temperature of the melt pool, e.g., 100-300° C. above the melting point of the encapsulating material 10. In addition, the sheath material 36 may comprise one or more materials selected from Table 2 below.

TABLE 1
High Temperature Thermocouple Types and Melting Points

| Thermocouple Type | Alloys | Maximum Temperature (C.) |
|---|---|---|
| S | Pt/Pt10Rh | 1550 |
| R | Pt/Pt13Rh | 1550 |
| B | Pt6Rh/Pt30Rh | 1700 |
| D | W3Re/W25Re | 2330 |
| C | W5Re/W26Re | 2330 |

TABLE 2
High Temperature Thermocouple Sheath Material and Melting Points

| Sheath Material | Alloys | Maximum Temperature (C.) |
|---|---|---|
| Fused Quartz | SiO2 | 1723 |
| Alumina | Al2O3 | 2030 |
| Zirconia | ZrO₂ | 2663 |
| Molybdenum | Mo | 2621 |
| Tantalum | Ta | 2999 |
| Tungsten | W | 3422 |

In an embodiment, the sheath material 36 comprises a material which does not allow for substantial fusion of the thermocouple 30 to the material of the cladding 24 or to the substrate 12. For example, in one embodiment, the sheath material 36 may comprise a zirconia material. Zirconia has a very high melting point, a relatively low thermal conductivity, and is not wetted by most molten metals such as superalloy materials. Thus, via use of zirconia or a like material, a snug encapsulation of the device 14, e.g., thermocouple 30, can be accomplished, but without fusion of the device 14 to the cladding 24, which may be a cast or sintered material. This is important since the difference in thermal expansion between zirconia and the cladding 24 or the substrate 12 would be very likely to cause breakage of the less ductile thermocouple sheath material (e.g., zirconia) 36 of the thermocouple 30 if fusion occurred.

In an embodiment, the encapsulation material 10, the device 14 (or material(s) to form the same), and flux powder 18 may be applied as distinct layers at different points in time. In other embodiments, it is appreciated that the components may be prepared in a form such that they are mixed or oriented together in the form of a powder, a wire, or a pre-form as are known in the art and are applied simultaneously onto the substrate.

In accordance with another aspect of the present invention, the device 14 may comprise an instrument that is formed in situ on the substrate 12. For example, the device may comprise a thermocouple that is formed in situ on the substrate 12. The formation of the thermocouple in situ may require the deposition of at least two distinct high temperature thermocouple materials on the substrate 12 such as those described above in Tables 1 and 2 to form a core which may then be encompassed (at least partially) by a sheath material for protection or which may be separated by an electrically non-conductive substrate material.

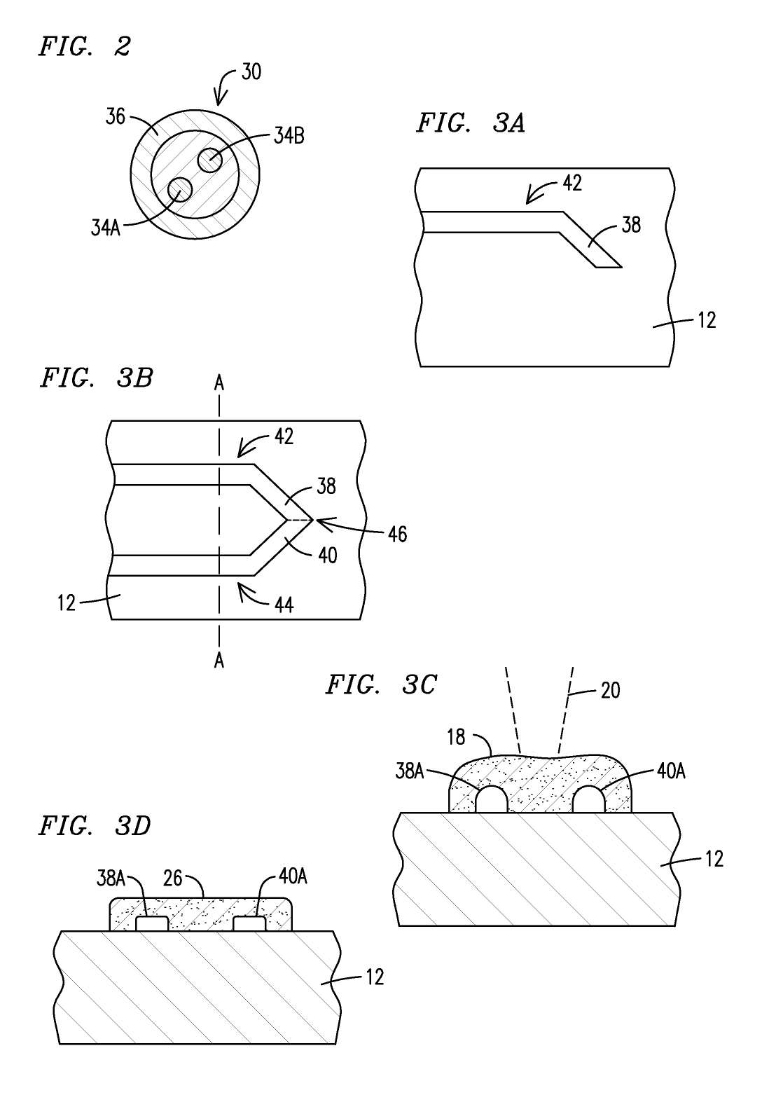

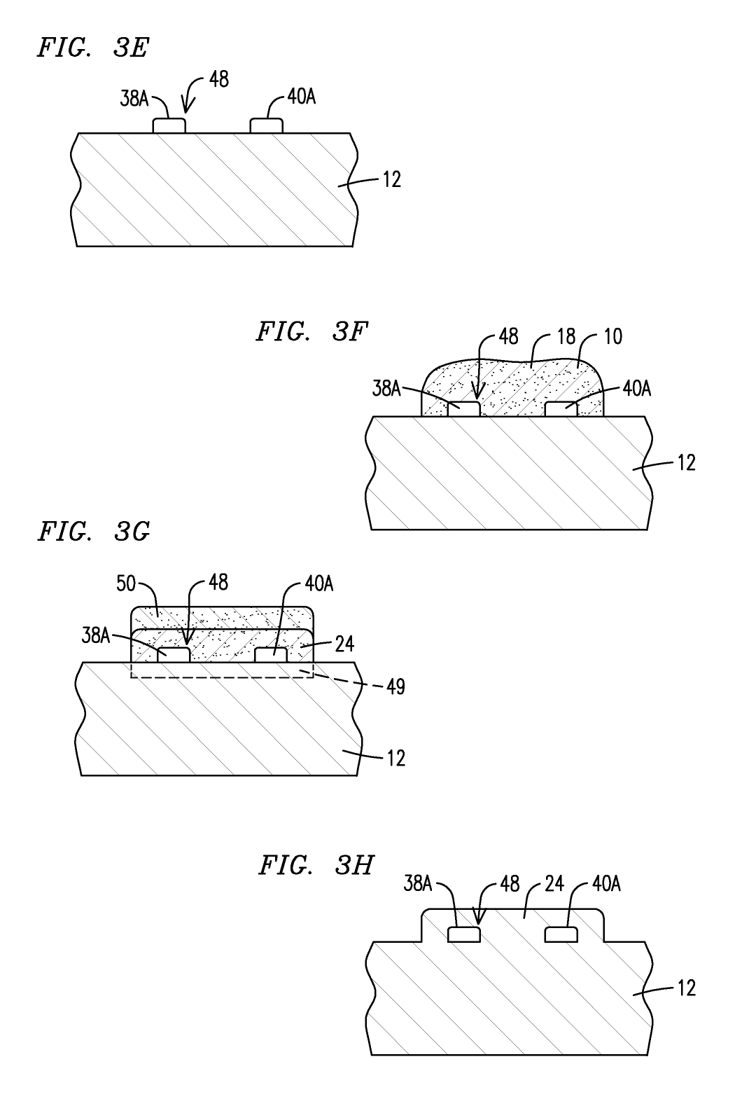

As shown in FIG. 3A (top view), for example, the device 14 on the substrate 12 may comprise a first thermocouple material 38 deposited on the substrate 12 in a first predetermined pattern. Prior thereto, simultaneously, or thereafter, a second (distinct) thermocouple material 40 may be applied on the substrate 12 as shown in FIG. 3B (top view). In an embodiment, the first thermocouple material 38 is applied in the first predetermined pattern 42 along a length of the substrate 12 and the second thermocouple material 40 is applied in a second predetermined pattern 44 spaced apart from the first predetermined pattern 42 as shown. The patterns intersect together and connect at an end thereof (junction 46). It is contemplated that any other components necessary for forming a thermocouple may also be applied along with the materials 38, 40 or over the materials 38, 40 as is necessary.

In this embodiment, upon the application of an effective amount of energy 20 from the energy source 22, the thermocouple materials 38, 40 are each melted at one end thereof to form the junction 46 and are additionally melted along their lengths and cooled, thereby adhering the cast (melted and resolidified) thermocouple materials 38A, 40A to the substrate 12. To prevent oxidation and porosity, an effective amount of flux powder 18 may also be applied over the cast thermocouple materials 38A, 40A as shown in FIG. 3C. FIG. 3C is a cross-section taken at line A-A in FIG. 3B. In certain embodiments, an amount of encapsulating material 10 may also be applied over and in contact with the substrate 12 between the cast thermocouple materials 38A, 40A and the substrate 12.

The energy source 22 applies an amount of energy 20 effective to melt the materials 18, 38 and 40, and melt or sinter any encapsulating material 10 (if present). Upon melting and resolidification of the resulting melt pool 16, a slag 26 is formed over the now solidified cast thermocouple materials 38A, 40A as shown in FIG. 3D. The slag 26 may be removed to provide the in situ formed thermocouple 48 on the substrate 12 as shown in FIG. 3E.

While the term “thermocouple” is used for the cast (resolidified) materials 38A and 40A, it is appreciated that the term “thermocouple” refers to the separated elements 38A and 40A shown in FIG. 3E, any insulating or sheath material disposed thereover, their junction 46 at a point for temperature measurement, and may also include extensions of the elements 38A and 40A to a voltage sensing device. Those extensions typically represent conductors (made of e.g. copper) and when so included may be factored into the temperature measurement because, just as the dissimilar metal junction between materials 38A and 40A results in voltage, the junction 46 between materials 38A and 40A and the extension wires can result in voltage. It is the voltage that develops as a function of the temperature gradient between the junction 46 and along the wires (formed from materials 38, 40) that produces a signal (voltage) which can be read at the other end of the (otherwise separated) wires and the junction 46, and diagnosed as a temperature at the junction 46.

Of note, it is appreciated that the flux material 18 may also serve as an insulator between or as a sheath material 36 for the cast thermocouple materials 38A, 40A formed from materials 38, 40, and thus an additional insulator or a separate sheath material may not be necessary. For example, alumina, silica, and zirconia are flux materials that are also suitable insulators or sheath materials for thermocouples. In an embodiment, the first and second thermocouple materials 38 and 40 are selected from the Table 1 and the flux powder 18 which also serves as a sheath is selected from a material in Table 2 above. Alternatively, any other additional or suitable sheath material may be applied over the thermocouple materials 38A, 40A.

Once the slag 26 has been removed (and any insulating/sheath materials have been added over or onto the cast thermocouple materials 38A, 40A if desired) leaving the exposed newly formed thermocouple 48, the encapsulating material 10 and additional flux material 18 may be disposed over, fed, or applied over the thermocouple 48 such as by disposing the encapsulating material 10 and the flux material 18 about the thermocouple 48 as shown in FIG. 3F. The encapsulating material 10 and the flux material 18 may be melted by energy 20 (FIG. 1A) and allowed to cool to form a cladding 24 that encapsulates the thermocouple 48 with a layer of slag 50 thereover as shown in FIG. 3G. In addition, in any of the embodiments described herein, the energy 20 may be effective to melt least a portion of a depth 49 of the substrate 12 so as to provide additional anchoring of the cladding 24 to the substrate 12 in the end product. This portion of the melted substrate 12 may be considered to be a portion of the cladding 24 as described herein upon resolidification. The slag layer 50 may be removed to leave behind the cladding 24 encapsulating the thermocouple 48 as shown in FIG. 3H.

In an embodiment, the components are provided in the formed of powders as was shown in FIGS. 3A-3H, which are placed upon the substrate 12 in the fashion described. Alternatively, any one or more of the components may be provided in the form of a pre-form such as a sleeving pre-form which is melted to provide the desired materials as energy is applied to an end of the pre-form to melt a portion thereof. In other embodiments, any one or more of the components (any of materials 10, 18, 38, 40, for example) may be provided in the form of a pre-sintered pre-form, which may be melted by the energy source 22 to provide the desired material for the process.

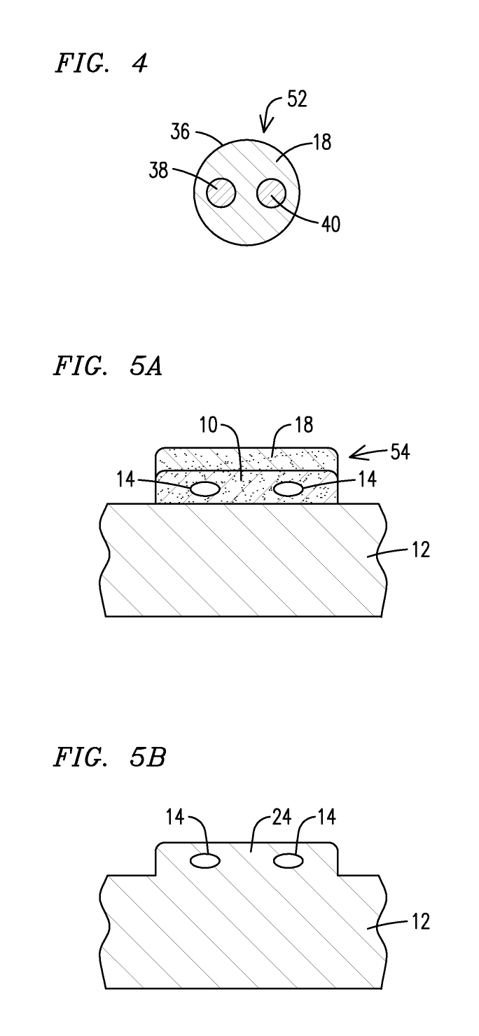

In a particular embodiment, for example, as shown in FIG. 4, the components for the thermocouple 30 may be collectively provided in a sleeving pre-form 52. An exemplary sleeving pre-form 52 may comprise, for example, a first pattern of a first thermocouple material 38 as previously described and a second spaced apart pattern of a second thermocouple material 40 within a body thereof. Alternatively, the pre-from 52 may comprise one or more fully assembled thermocouples. In addition, the pre-form 52 may further include a flux material 18 dispersed therein about the materials 38, 40. The materials 38, 40 (or assembled thermocouple) and 18 are encompassed by a sheath material 36. As the energy source 22 or substrate 12 advances with respect to the other of the energy source 22 and the substrate 12, the sleeving pre-form 52 will be melted and cooled to provide a thermocouple encompassed by a slag 26 as described herein. The slag 26 may be removed and the thermocouple 30 may then be encapsulated with the cast or sintered encapsulating material 10 by feeding or applying the encapsulating material 10 over the thermocouple materials, melting or sintering the encapsulating material 10, and cooling. Flux material 18 may also be fed or applied with the encapsulating material 10, melted, cooled, and removed to prevent oxides and porosity from forming.

In still another embodiment, the components to be deposited in any of the processes described herein may be provided in the form of a pre-sintered pre-form (PSP) 54 as is known in the art, which may be placed directly on the substrate 12. As shown in FIG. 5A, the PSP 54 comprises the encapsulating material 10 having a device 14 dispersed therein, which may be a thermocouple, components for the same, or another monitoring device. The PSP 54 may further include a top layer of the flux powder 18. Once disposed on the substrate, the PSP 54 may be melted by the energy source 22 and the slag 26 removed as previously described herein to leave a cladding 24 that encapsulates a device 14 as shown in FIG. 5B. In certain embodiments, a depth of the substrate 12 may also be melted during the melting step.

The processes described herein result in a novel component wherein a device can now be positioned within a cast superalloy component. Traditional casting processes used for superalloy components involve very high temperatures and the mechanically violent injection of molten superalloy material into a ceramic mold. Such processes would destroy any device positioned within the mold. In contrast, processes as described herein, wherein powdered superalloy material is melted with an energy beam to form a cladding layer of cast (melted and resolidified) superalloy material are less violent and are more temperature controlled, thereby facilitating the survival of a device positioned within the cast superalloy material. The deposited layer of superalloy material is metallurgically bonded to and may become integral with the underlying substrate material, and its grain structure can be controlled by appropriate heat flow control as with any other casting. As was illustrated in FIG. 1B, the substrate 12 has a device 14 at least partially encapsulated within a cladding 24 on the substrate 12, wherein the encapsulating material 10 is cast by melting and resolidifying a powdered encapsulating material 10 to form the cladding 24. In certain embodiments, the substrate 12 and the encapsulating material 10 each comprise a superalloy material.

It is appreciated that the device 14 may be cast on the substrate 12 in such a manner that the substrate and the cladding 24 resulting from the encapsulating material 10 includes at least substantially the same direction of grain growth. For example, in an embodiment, the substrate 12 and the cladding 24 comprise materials that are directionally solidified in at least substantially the same direction (e.g., less than 20 degrees difference relative to one another in a selected direction). In certain embodiments, the substrate 12 and the cladding 24 are solidified in the same direction.

In certain embodiments, the molten superalloy material may be solidified to extend a single crystal structure of the substrate, or it may be solidified directionally to extend substrate grains, as are known to those skilled in the art. See U.S. Pat. No. 6,024,792 and EP 0 892 090 A1, the entirety each of which is hereby incorporated by reference. Dendritic crystals may be oriented along the direction of heat flow and form either a columnar crystalline grain structure or a single-crystal structure. In certain embodiments, the encapsulating material 10 selected for encapsulating a device 14 may be solidified so as to optimally match the grain structure of the underlying substrate 12 such that there are few, if any, interfaces between the substrate 12 and the resulting cladding 24, thereby forming an integral casting. It is understood that the present invention is not so limited, however, and that the cladding 24 and the substrate 12 may have a different grain orientation if so desired, such as an equiaxed structure deposited on a directionally solidified structure, or vice versa. In other embodiments, the entire component may be cast by the layer-by-layer powder deposition process, with the device being deposited at any desired depth within the component thickness. In other embodiments, the powdered encapsulating material 10 may be sintered by the energy beam 20 to form the cladding 24 rather than being melted and resolidified.

In addition, it is appreciated that following the preparation of the cladding 24 encapsulating one or more devices 14, any further coatings may be added to the cladding 24. For example, coatings to further protect the cladding 24 with the encapsulated device and the substrate 12 against corrosion or oxidation may be provided. The additional coatings may comprise a bond coat of the general formula MCrAIX, where M=one or more of Fe, Co, and Ni; and X=Y, Si, Hf, one or more rare earth elements, and combinations thereof. A protective aluminum oxide layer (TGO=thermal grown oxide layer) may be formed on the MCrAIX layer. Further, an additional thermal barrier coating as is known in the art may be applied over the bond coat or aluminum oxide layer. See US Published Patent Application No. 2009/0162648, the entirety of which is hereby incorporated by reference.

The flux material 18 may comprise a flux powder of a size and composition as described in U.S. Published Patent Application No. 2013/0136868, for example, the entirety of which is hereby incorporated by reference herein. The use of a flux powder has a plurality of advantages associated therewith. The layer of slag 26 formed by flux material 18 provides a number of functions that are beneficial for the final product. First, during melting of material, the layer of slag 26 may shield both the region of molten material and the solidified (but still hot) material from the atmosphere in the region downstream of the energy source. Second, the layer of slag 26 floats to the surface of melt pool to separate the molten or hot metal from the atmosphere, and the flux powder may be formulated to produce a shielding gas in some embodiments, thereby avoiding or minimizing the use of expensive inert gas or need for vacuum processing. Third, the slag 26 may act as a blanket that allows the solidifying material to cool slowly and evenly, thereby reducing residual stresses that can contribute to post weld reheat or strain age cracking. Fourth, the slag 26 may help to shape the melt pool to keep it close to a desired ⅓ height/width ratio. Fifth, the flux material 18 provides a cleansing effect for removing trace impurities, such as sulfur and phosphorous, which contribute to weld solidification cracking. Such cleansing may include substantial deoxidation of the metal powder and substantially prevent oxide and porosity formation. Because the flux material 18 is in intimate contact with the materials described herein during processing, the flux material 18 may be especially effective in accomplishing these functions.

Exemplary flux powders which could be used in the processes described herein include commercially available fluxes such as those sold under the names Lincolnweld P2007, Bohler Soudokay NiCrW-412, ESAB OK 10.16 or 10.90, Special Metals NT100, Oerlikon OP76, Sandvik 50SW or SAS1. The flux particles may be ground to a desired smaller mesh size range before use. In particular embodiments, the flux powder is specially adapted for the particular superalloy material being processed as described in U.S. Published Patent Application No. 2013/0136868 or U.S. Provisional Patent Application Ser. No. 61/859,317 (attorney docket no. 2013P12177US, filed Jul. 29, 2013, entitled “Flux for Laser Welding”), each of which is hereby incorporated by reference as if fully set forth herein. In an embodiment, the volume ratio of the flux material 18 to the material 10 is from 3:2 to 2:3, and in certain embodiments is 1:1.

In the embodiments described herein, the slag 26 may be removed using any suitable method known in the art. It is appreciated that the slag 26 is typically a solid layer that is substantially brittle. In certain embodiments, the slag 26 may thus be broken by mechanical methods, such as by cracking the slag 26 with a blunt object or vibratory tool, and sweeping away the slag 26. In other embodiments, the slag 26 (once formed) may self-detach upon cooling.

Further, in the embodiments described herein, the energy source 22 may comprise a diode laser beam, although other known types of energy beams may be used, such as electron beam, plasma beam, one or more circular laser beams, a scanned laser beam (scanned one, two or three dimensionally), an integrated laser beam, or the like. In an embodiment, the energy 20 has a generally rectangular cross-sectional shape. The rectangular shape may be particularly advantageous for embodiments having a relatively large area to be clad, such as for repairing the tip of a gas turbine engine blade.

While various embodiments of the present invention have been shown and described herein, it will he obvious that such embodiments are provided by way of example only. Numerous variations, changes and substitutions may be made without departing from the invention herein.

1. A deposition process comprising:
disposing a device at least partially within an encapsulating material and a molten flux material on a substrate;
cooling the encapsulating material and the molten flux material to form a cladding that encapsulates the device and a slag layer formed over the cladding; and
removing the slag layer to leave behind the cladding that encapsulates the device.

2. The process of claim 1, wherein the disposing is done by:
adding the encapsulating material, the device, and the flux material to the substrate; and
melting the encapsulating material and the flux material via an effective amount of energy from an energy source.

3. The process of claim 2, wherein at least a portion of a depth of the substrate is also melted during the melting.

4. The process of claim 1, wherein the energy source comprises a laser energy source, and wherein the encapsulating material and the flux material are provided in the form of a member selected from the group consisting of a powder, a wire, a fabric, and a pre-form.

5. The process of claim 1, wherein the substrate and the encapsulating material both comprise a material selected from the group consisting of a superalloy material and a ceramic material.

6. The process of claim 1, wherein the cladding, comprises less than 5 vol % of oxides and less than 5 vol. % porosity.

7. The method of claim 1, wherein the device comprises a wire or an instrument configured to monitor a property selected from the group consisting of temperature, heat flux, strain, pressure, and a load, or comprises a device configured to alter the substrate by at least one of heating, cooling, or producing an electromagnetic field.

8. The method of claim 7, wherein the device comprises a thermocouple.

9. The method of claim 8, wherein the thermocouple is disposed on the substrate by:
disposing the encapsulating material, the thermocouple, and the flux material on the substrate;
melting the encapsulating material and flux material on the substrate;
cooling the molten encapsulating material, the thermocouple, and the molten flux material; and
removing the slag layer to leave behind a cladding that encapsulates the thermocouple.

10. The method of claim 9, wherein the thermocouple comprises a first thermocouple material and a second material encompassed by a sheath material, and wherein the thermocouple is not melted by the melting.

11. The method of claim 10, wherein the sheath material comprises a material that does not fuse to the encapsulating material or to the substrate.

12. The process of claim 1, wherein the device comprises a thermocouple, and wherein the disposing the thermocouple on the device is done by a process comprising:
disposing a first thermocouple material over the substrate in a first predetermined pattern;
disposing a second thermocouple material over the substrate in a second predetermined pattern spaced apart from the first thermocouple material and intersecting with the first thermocouple material at a junction;
disposing a flux material over the first and second thermocouple materials;
melting the first and second thermocouple materials and the flux material;
cooling molten first and second thermocouple materials and molten flux material to form a slag layer over a thermocouple;
removing the slag layer; and
encapsulating the thermocouple with the encapsulating material.

13. The method of claim 12, wherein the encapsulating the thermocouple with the encapsulating material comprises:
disposing the encapsulating material and additional flux material over the resolidified thermocouple;
melting the encapsulating material and the additional flux material;
cooling the molten encapsulating material and the molten additional flux material to form a cladding encapsulating a thermocouple and a slag layer over the cladding; and
removing the slag layer.

14. The method of claim 12, wherein the first thermocouple material, the second thermocouple material and the flux material are provided collectively as a pre-form.

15. The method of claim 1, wherein the disposing comprises:
adding the encapsulating material, the device, and the flux material to the substrate, wherein the encapsulating material comprises a ceramic material; and
applying an amount of energy from an energy source effective to melt the flux material and sinter the ceramic encapsulating material.

16. A deposition process comprising:
adding an encapsulating material, a device, and a flux material to a substrate;
melting the encapsulating material and the powdered flux material to form molten encapsulating material, the device, and molten flux material;
cooling the molten materials to form a slag layer over a cladding at least partially encapsulating the device; and
removing the slag to leave behind the cladding at least partially encapsulating the device on the substrate.

17. The process of claim 16, wherein the device comprises a thermocouple, and wherein the adding comprises:
disposing a first thermocouple material over the substrate in a first predetermined pattern;
disposing a second thermocouple material over the substrate in a second predetermined pattern that is parallel to the first thermocouple material;
disposing a flux material over the first and second thermocouple materials;
melting the first and second thermocouple materials and the flux material;
cooling molten first and second thermocouple materials and molten flux material to form a slag layer over a cast thermocouple; and
removing the slag layer.

18. A component comprising:
a substrate;
a device at least partially encapsulated by a cladding on the substrate, wherein the cladding comprises a cast superalloy material.

19. The component of claim 18, wherein the encapsulating material and the substrate comprise a superalloy material, and wherein the substrate and the cladding comprise the same grain orientation.

20. The component of claim 18, wherein the encapsulating material comprises a sintered material.
